(19) United States
(12) Patent Application Publication
(10) Pub. No.: US 2004/0255337 A1
(43) Pub. Date: Dec. 16, 2004

(54) Method of synchronization

(75) Inventors: Eric Doyle, Ottawa (CA); Noel Murphy, Ottawa (CA); Michael McMillan, Nepean (CA); Catherine Doyle, Manotick (CA)

Correspondence Address: MARKS & CLERK, P.O. BOX 957, STATION B, OTTAWA, ON, K1P 5S7, CA

(73) Assignee: Impatica Inc.

(21) Appl. No.: 10/779,601

(22) Filed: Feb. 18, 2004

Related U.S. Application Data
(60) Provisional application No. 60/447,743, filed on Feb. 19, 2003.

(51) Int. Cl. H04N 7/16; H04N 7/12; H04N 11/02; H04N 11/04

(52) U.S. Cl. 725/135; 725/136; 348/385.1

(57) ABSTRACT

In a method of synchronizing first and second data streams, the first data stream acting as a reference stream, elements of the first data stream are displayed along a time line on a display device. Containers for elements of the second data stream are displayed on the display device alongside the elements of the first data stream. The containers are interactively displaced on the display device relative to the elements of the first data stream to align the containers with cue elements in the first data stream. Synchronization markers are generated for the aligned displayable elements relative to the first data stream.

### CROSS REFERENCE TO RELATED APPLICATION

This application claims the benefit under 35 USC 119(e) of U.S. provisional application No. 60/447,743, filed Feb. 19, 2003, the contents of which are herein incorporated by reference.

### FIELD OF THE INVENTION

This invention relates to the field of data processing, and in particular to a method of synchronizing streams of real time data. The method is applicable to the synchronization of a data stream, for example, controlling a slide presentation with a video stream.

### BACKGROUND OF THE INVENTION

PowerPoint™ by Microsoft Corporation is a well known software presentation package that permits the user to create animated slides to present information to an audience. PowerPoint™ makes full use of animated visual presentation techniques such as flying bulleted lists and the like to have maximum impact on the audience. PowerPoint™ presentations cannot be sent over networks, such as the Internet, without prohibitive and clumsy additional programs, known as plug-ins.

Impatica Inc. of Ottawa, Canada has developed a product, known as ImpaticaonCue™, which permits the integration of PowerPoint™ presentations with video and the transmission of the resulting product over the Internet for easy display on a web browser without the need for complex plug-ins. ImpaticaonCue™ allows clients to deliver synchronized plug-in free video and PowerPoint™ presentations over the Internet. The synchronization ensures that, for example, when a presenter appearing in a window refers to a specific item, the appropriate slide, or bulleted paragraph within a slide appears in the slide window.

ImpaticaonCue™ processes PowerPoint™ files to generate streaming data, referred to as an impaticized presentation, which is integrated with the video. In order synchronize the video with the impaticized presentation or streaming data, it is necessary to create a synchronization file consisting of a series of timing cues that associates slides, or events within slides, with particular frames of the video data. This file basically just lists the events in the slide presentation and associates them with a timestamp from the start of the streaming data. For example, the synchronization file might indicate that a particular frame is to appear 5.3 seconds from the start of the video, or that a particular event within a slide, such as the appearance of a bullet, is to appear 5.8 seconds from the start of the video. The synchronization file works by associating these events with particular times.

ImpaticaonCue™ generates an output by reading the video/audio file, the animated slide presentation, and the synchronization file, together with any narrative markup, and assembling these components into a single output stream with the timings determined by the contents of the synchronization file. More details on ImpaticaonCue™ can be found on the Impatica website at www.impatica.com.

The preparation of the synchronization file is done manually and can be a tedious business. It is necessary to view the video, note the timings for each event, and enter these manually into the synchronization file.

### SUMMARY OF THE INVENTION

The invention provides a method of allowing the user to visually synchronize the video with the presentation data.

Accordingly the present invention provides a method of synchronizing first and second data streams, said first data stream acting as a reference stream, comprising displaying elements of said first data stream on a display device along a time line; displaying containers for elements of said second data stream on said display device alongside said elements of said first data stream; interactively displacing said containers on said display device relative to said elements of said first data stream to align said containers with cue elements in said first data stream; and generating synchronization markers for said aligned displayable elements relative to said first data stream.

In one embodiment the first data stream is a video stream, and the elements of the first data stream are video frames. The elements of the second data stream can, for example, be PowerPoint™ slides, or animation events within slides. At a first level, the user might align a particular slide with a particular video frame and generate an appropriate synchronization marker. The user might then expand the video stream and move to animation events within the slide to generate synchronization markers that are associated with the animation events, such as flying bullets and the like. These events are associated with “atoms” appearing within the containers. The containers themselves can be assembled into container “drawers within a multilevel hierarchy.

In one embodiment, the synchronization markers are output into a synchronization file that can be read by ImpaticaonCue™ to create an output stream for display on a standard web browser.

The containers may be interconnected so that they move together. As one container is displaced on the display device relative to the video stream, downstream containers are correspondingly displaced at the same time, an effect known as bulldozing.

The invention also provides an apparatus for synchronizing first and second data streams, said first data stream including video frames and said second data stream including a series of displayable elements, comprising a display device; a first software component for displaying video frames of said first data stream on a display device; a second software component for displaying said containers for said displayable elements of second data stream on said display device alongside said video frames of said first data stream; a pointer for interactively displacing containers on said display device relative to said video frames to align said containers with video cues; and a third software component for generating synchronization markers for said aligned displayable elements.

The apparatus is typically in the form of a programmed personal computer with a monitor, central processing unit, storage device, keyboard and mouse providing the pointing device.

### BRIEF DESCRIPTION OF THE DRAWINGS

The invention will now be described in more detail, by way of example only, with reference to the accompanying drawings, in which:-

FIG. 1 is a block diagram of the overall synchronization process in accordance with one embodiment of the invention;

FIG. 2 shows the composition of a project;

FIG. 3 shows the composition of a presentation object stream;

FIG. 4 shows the elements of a user interface sample;

FIG. 5 is a flow chart showing the selection and displacing of a container object;

FIG. 6 is a flow chart showing the selecting and moving of an atom object;

FIG. 7 is a flow chart showing the bulldozing of presentation stream components;

FIG. 8 shows bulldozing a container if required;

FIG. 9 shows the bulldozing of a container;

FIG. 10 shows the bulldozing of atoms if required;

FIG. 11 shows the bulldozing of atoms in a container;

FIG. 12 shows the processing of atoms for a container; and

FIG. 13 shows how to establish drawer placement of an atom.

### DETAILED DESCRIPTION OF THE PREFERRED EMBODIMENTS

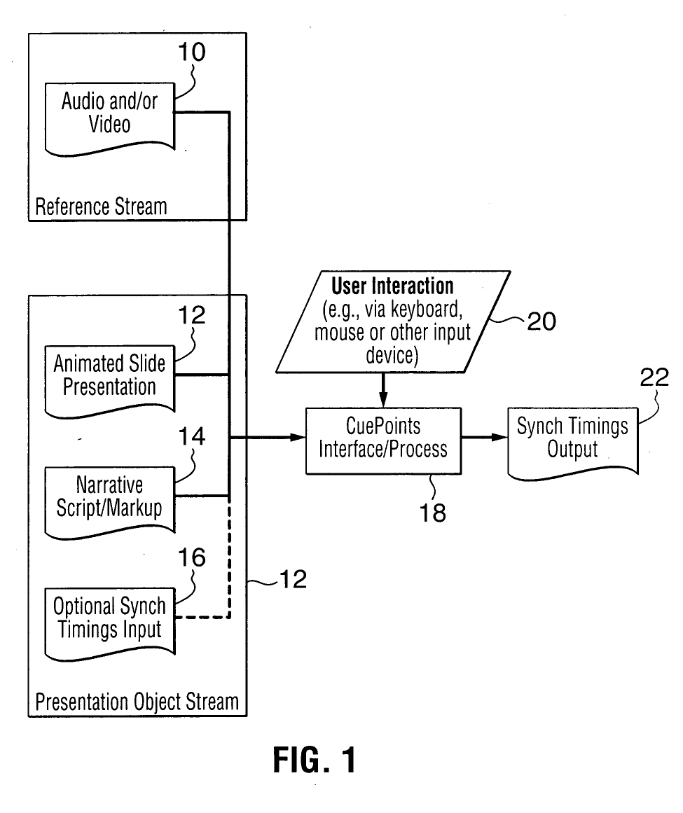

FIG. 1 shows the basic implementation of a system for which an embodiment of the invention is applicable. The system results in a complete assembly of components that can be displayed on a standard web browser, consisting of video, associated animated slides, and added narrative and markup. The viewer sees both the presenter and animated slides in windows on the screen.

A video stream 10, which is accompanied by suitable audio, constitutes a reference stream. The video stream is typically a video of a presenter giving a PowerPoint™ presentation. This presentation is accompanied by animated slides created by PowerPoint™.

The PowerPoint™ presentation is “impaticized” using software commercially available from Impatica Inc. to create a data stream 12 that is to be merged with the video stream 10 and that can be displayed in a standard web browser without the need for additional plug-ins. In addition, the data stream 12 can be merged with a narrative or script markup 14 containing titles or comments relating to the presentation.

Optional additional synchronization timings can be also supplied as an additional data stream 16.

The data streams are fed into the interface process 18, which with the aid of user input 20, generates an output file 22 containing all the synchronization timings necessary to display the entire presentation, video, animated slides, and markup, on the browser of a client computer. The synchronization file contains all the timings, relative to the start of the video stream, of each event in the presentation. For examples, slides will appear at appropriate times relative to the video stream, and bulleted lists will appear at the appropriate times within the slides for the context of the presentation. As the presenter refers to a specific point, the appropriate slide and/or item within a slide will appear on the client computer.

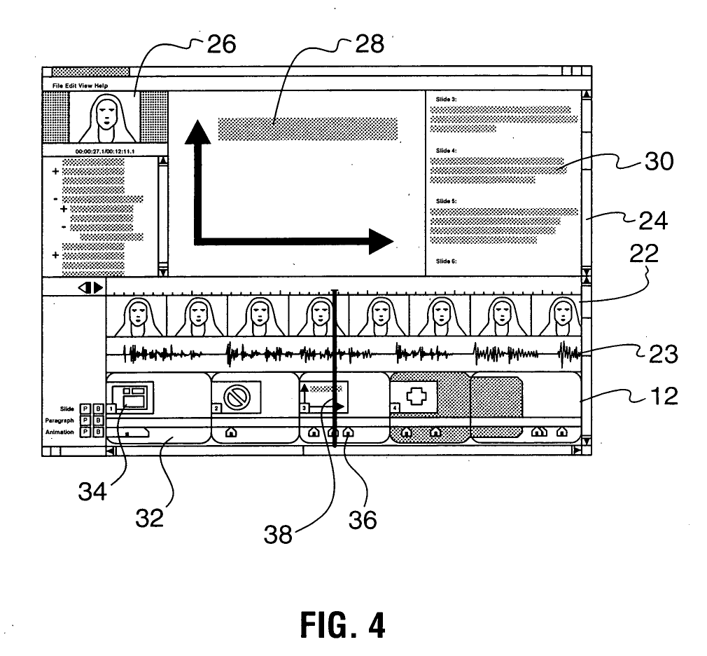

In order to create the synchronization file, the video stream 22 along with accompanying audio 23 is displayed along a timeline 22 on a computer monitor 24, as shown in FIG. 4. The computer displays a series of windows including a real time view 26 of the video stream, a real time view of the object stream 28, and narrative or markup 30 associated with the slides.

The second data stream 12 is displayed alongside the first data stream. The second stream contains animated PowerPoint™ slides34. These are displayed within “containers” or frames 32 alongside the video stream 22 that acts as a reference. The containers can be grabbed with a mouse and dragged along the time line to any suitable position. The containers interact so that as one is dragged along the timeline, it pushes the others along in front of it, an effect known as “bulldozing”. Both data streams are scrollable along the time line.

In order to align a particular slide with a particular video cue represented, the container for the slide in question is dragged along the time line with the mouse until it is aligned with the desired video frame. The video can be played in real time with sound in window 26 to assist in locating the appropriate frame. The user then releases the container at the desired location and enters the cue, for example, by clicking a mouse button, to generate the synchronization marker to be output to the file. The software then creates an entry in the output file that associates this particular slide with a particular timing relative to the start of the video stream.

A similar process is carried out with respect to animated components of the slides. These are associated with atoms within the container. The atoms can be dragged within the slides in a similar manner to the containers. An atom for a particular bullet, for example, is aligned with the desired video frame and a cueing action taken to generate the synchronization marker, which is then output to the file.

As the video is played in the window 26, play bar 38 moves along the video reference stream 22 in synchronization therewith. When play is stopped, the play bar 38 stops at the corresponding frame, and in this way enables the containers and atoms to be dragged to a desired point in the reference stream. When the cue is entered, for example, by clicking the mouse, the appropriate entries are generated in the output file.

The software components are written primarily using java script.

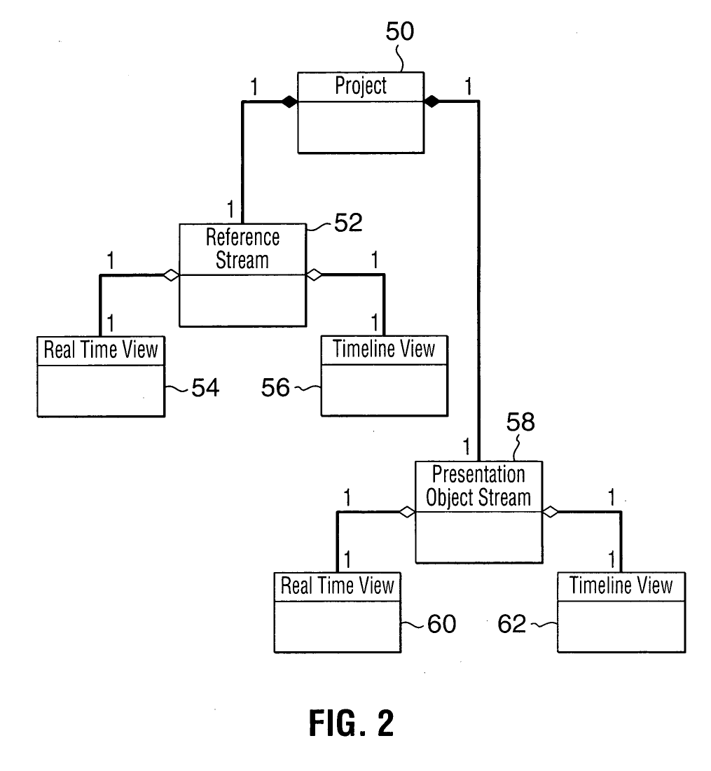

Referring to FIG. 2, the project 50 consists of a reference stream 52 consisting of a realtime view 54 and timeline view 56, and presentation object stream 58 consisting of real time view 60 and time line view 62.

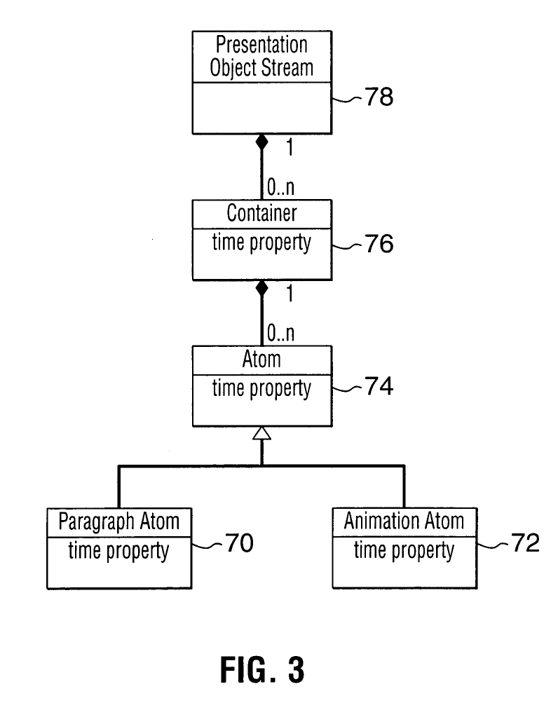

As shown in FIG. 3, the presentation object stream is composed of a paragraph atom 70 and an animation atom 72, which merge to form atom 74 within container 76 within the object stream 78.

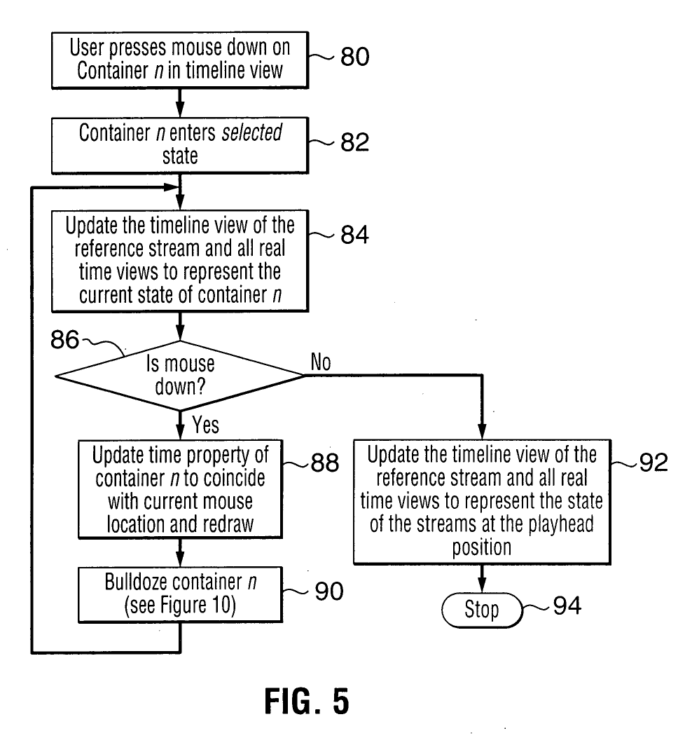

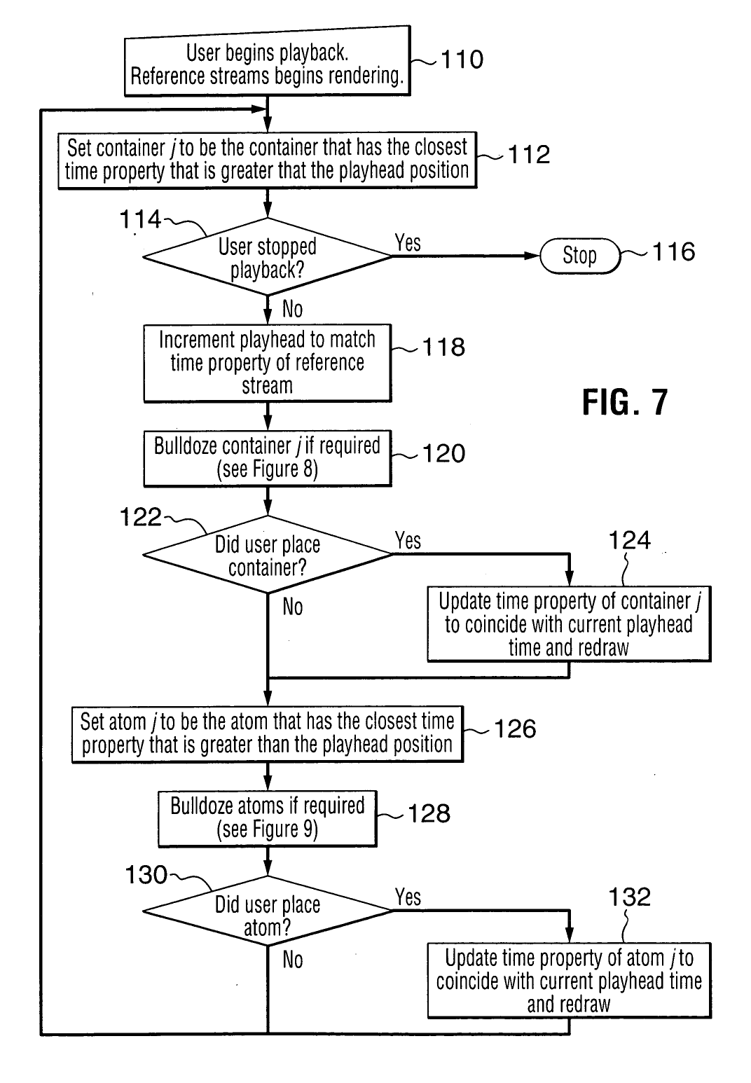

FIGS. 5 to 13 illustrate the detailed flow charts for implementing the processes described above. The invention is typically implemented on a Java-enabled standard personal computer.

In FIG. 5, at step 80 the user presses the mouse on container n in the timeline view. At step 82 the container n enters the selected state. The timeline view of the reference stream and all the real time views are updated at step 84 to represent the current state of the container n.

At step 86, a determination is made as to whether the mouse is down. If so, the property of the container n is updated to coincide with the current mouse location and redrawn at step 88. If not the time line view of the reference stream and all the real time views are updated to represent the state of the streams at the playhead position at step 92. The process terminates at 94.

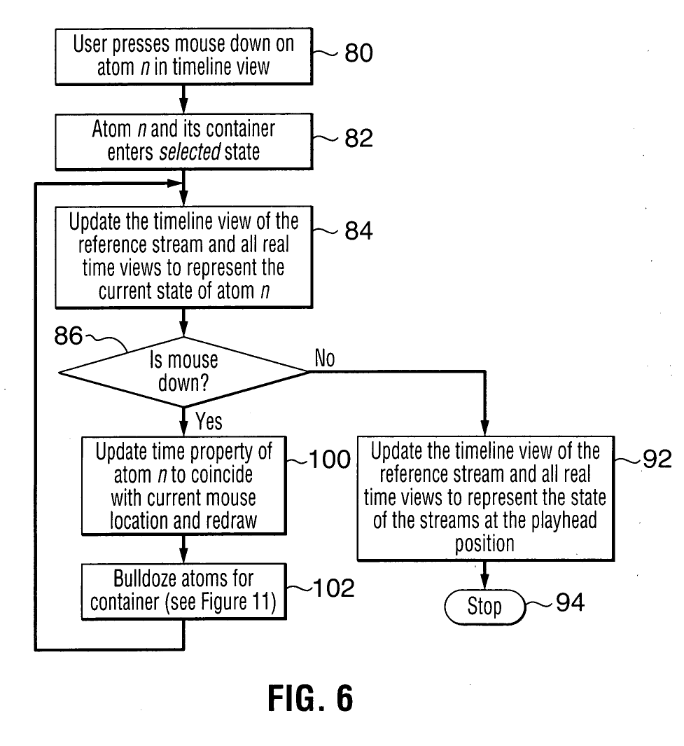

FIG. 6 shows the selecting an moving of an atom object. The steps are the same as in FIG. 5, except that if the mouse is down at step 86, the time property of the atom n is updated to coincide with current mouse location at step 100 and the atoms are bulldozed (i.e. pushed together) for the container at step 102.

FIG. 6 illustrates the bulldozing of presentation stream components. At step 100, the user begins playback. At step 112, container i is set to be the container that has the closest time property that is greater than the playback position.

at step 114, the user has stopped playback the process terminates at step 116. If not, the playhead is incremented at step 118 to match the time property of the reference stream. At step 120, the container i is bulldozed if required. At step 122 a determination is made as to whether the user placed a container. If yes, the time property of the container i is updated to coincide with the current playhead time, and the screen redrawn at step 124.

If not, the atom j is set as the atom that has the closest time property that is greater than the playhead position at step 126. The atoms are bulldozed if required at step 128.

At step 130, a determination is made as to whether the user placed an atom. If yes, the time property of atom j is updated at step 132 to coincide with the current playhead time.If not, the process loops back to step 112.

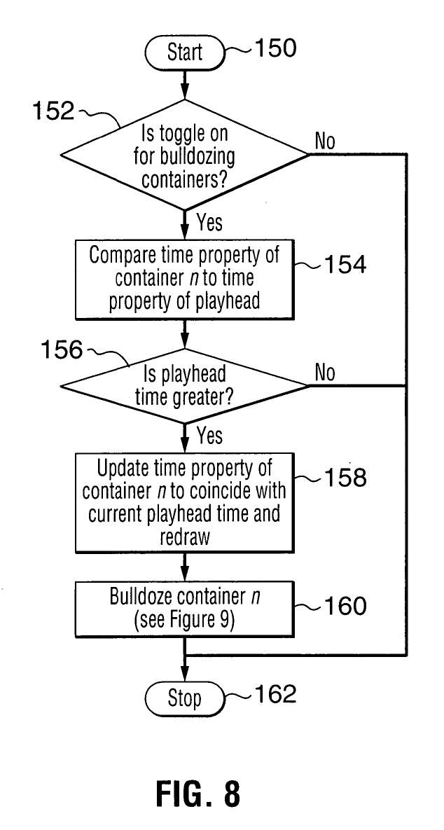

FIG. 8 discloses a process for bulldozing a container. The process starts at 150. A determination is made at step 152 if the toggle is on for bulldozing containers at step 152. If yes, the time property of container n is compared to the time property of the playhead at step 154. If no the process terminates at step 162.

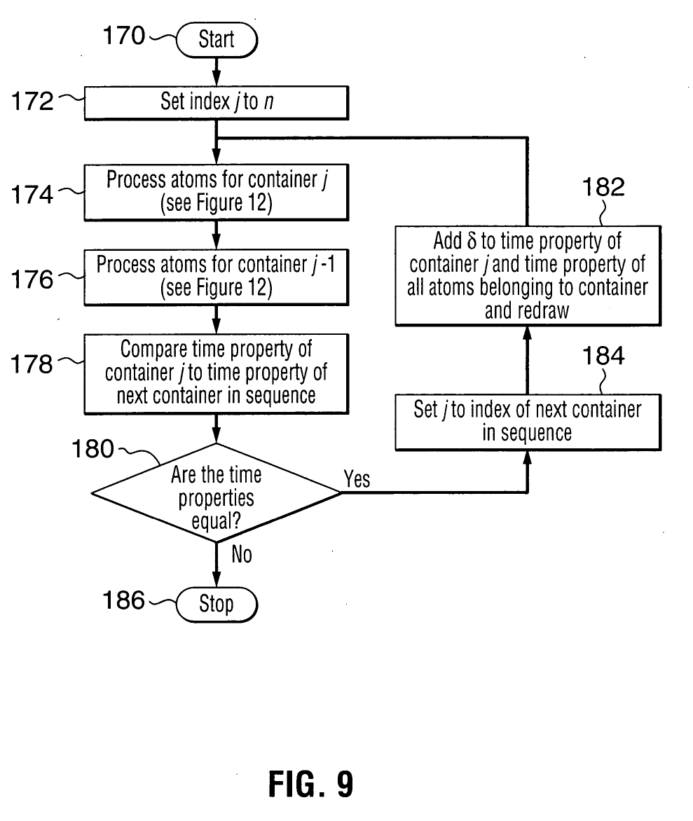

step 156 a determination is made as to whether the playhead time is greater. If no, the process terminates. If yes, the time property of the container n is updated to coincide with the current playhead time and the screen redrawn at step 158. The container n is bulldozed at step 160 as described in more detail with reference to FIG. 9.

As shown in FIG. 9, the bulldozing of the container starts at step 170. The index i is set to n at step 172. The atoms for container i are processed at step 174, and the atoms for container i-1 processed at step 176. At step 178, the time property of container i is compared to the time property of the next container in sequence. The time properties are not determined to be equal at step 180, the process terminates, if they are, the index i is set to the next container in the sequence at step 184, and an increment δ is added to the time property of all atoms belonging to the container and the screen redrawn at step 182.

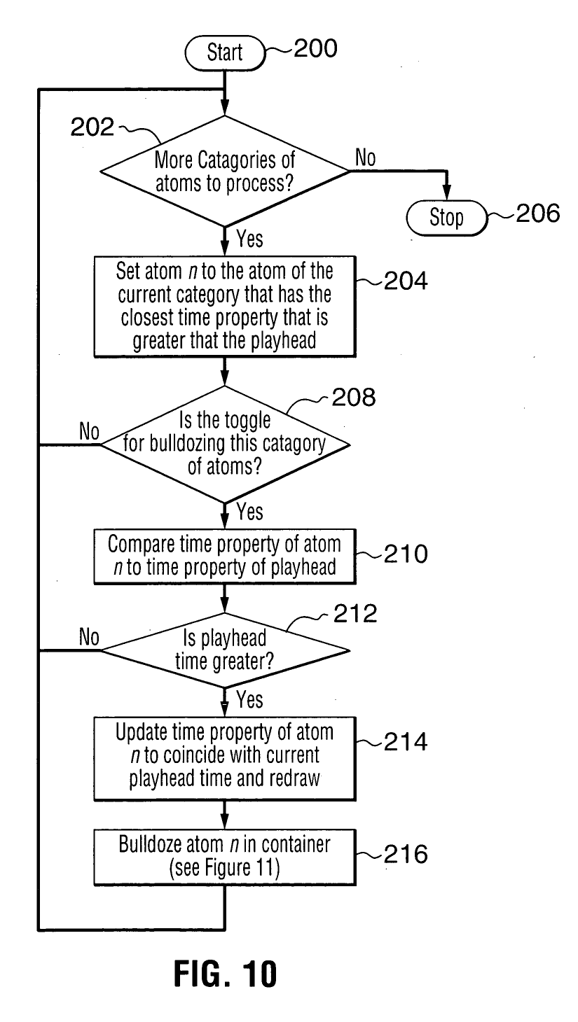

FIG. 10 shows how to bulldoze atoms if required. The process starts at step 200. If there are no more categories of atoms to process the process stops at 206. If there are, the atom n is set to the atom of the current category that has the closest time property that is greater than the playhead at step 204.

At step 208, a determination is made whether the toggle is set for bulldozing atoms. If yes, the time property of atom n is compared to the time property of the playhead. Step 212 determines if the playhead time is greater. If yes, the time property of atom n is update to coincide with the current playhead time and the screen redrawn at step 214. The atom n is bulldozed in the container at step 216.

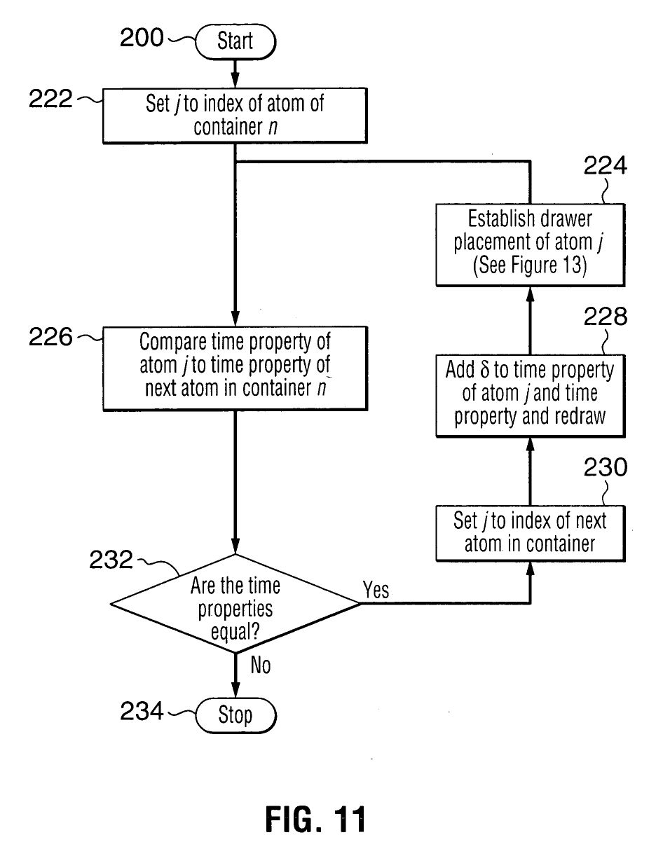

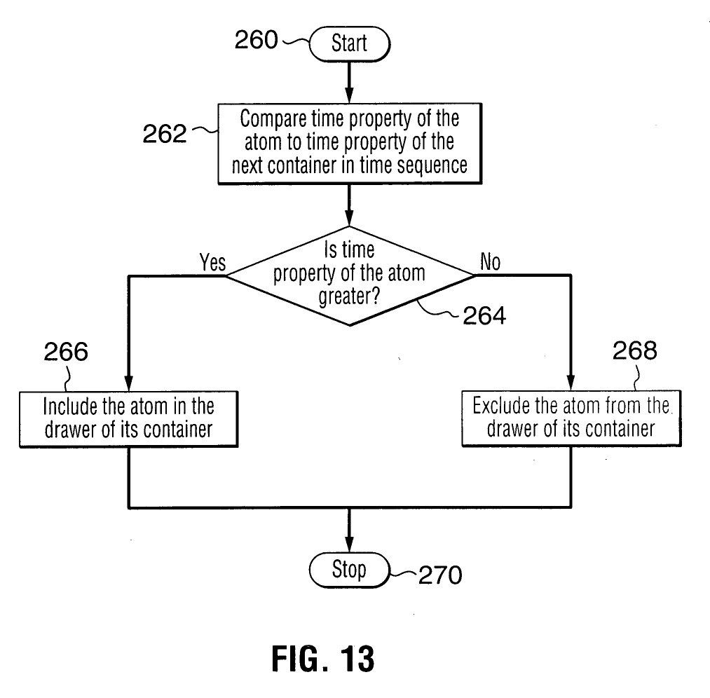

FIG. 11 illustrates the process for bulldozing atoms in a container. The process starts at step 220. The index i is set to the index of an atom of container n at step 222. The time property of atom i is compared to the time property of the next atom in container n at step 226. If the time properties are not equal at step 232, the process stops at 234. If they are equal, the index i is set to the index of the next atom in the container, an increment δ is added to the time property of atom i and the screen redrawn. The drawer placement of atom i is established at step 224, shown in more detail in FIG. 13.

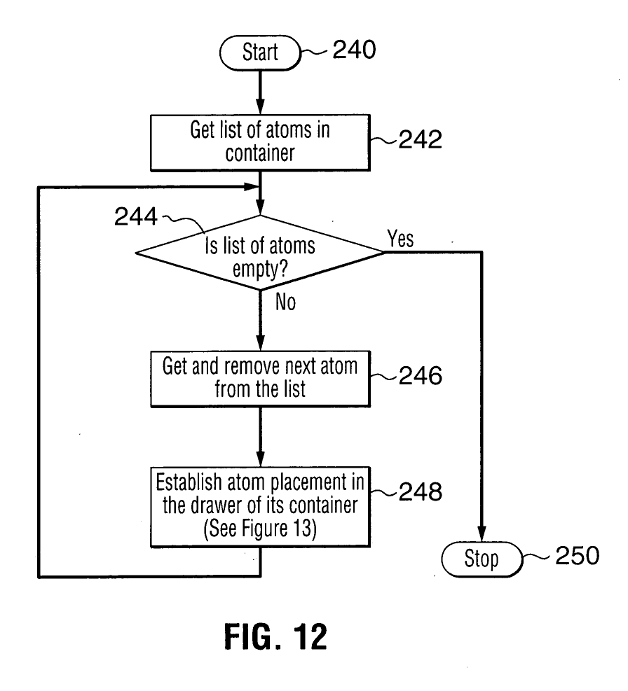

FIG. 12 shows the process for processing atoms in a container. The process starts at step 230. A list of atoms is obtained at step 242. If step 244 determines the list of atoms is empty, the process stops at step 250. If not the next atom is obtained at step 246 and removed from the list. The atom placement in the drawer is established at step 248 as shown in FIG. 13.

In FIG. 13, the process starts at step 260. The time property of the atom is compared to the time property of the next container in time sequence at step 262.

At step 264, a decision is made whether the time property of the atom is greater. If yes, the atom is included in the drawer of its container at step 266. If no, the atom is excluded from the drawer of its container at step 268.

The process terminates at step 270.

It will be seen that the method in accordance with the invention permits a user to rapidly generate a synchronization file that can be used by ImpaticaonCue™ to generate streaming data for transmission over the Internet to a client computer, where it can be displayed in multiple windows on a browser without the need for plug-ins using an impaticized PowerPoint™ output and a video input, typically from a digital video camera. The method in accordance with the invention makes the generation of the synchronization file a rapid task that can be carried out by the user without the need for tedious and manual entry of timing data into a file.

We claim:

1. A method of synchronizing first and second data streams, said first data stream acting as a reference stream, comprising:
displaying elements of said first data stream on a display device along a time line;,
displaying containers for elements of said second data stream on said display device alongside said elements of said first data stream;
interactively displacing said containers on said display device relative to said elements of said first data stream to align said containers with cue elements in said first data stream; and
generating synchronization markers for said aligned displayable elements relative to said first data stream.

2. A method as claimed in claim 1, wherein said first data stream is a video stream, and said elements thereof are video frames.

3. A method as claimed in claim 1, wherein said containers correspond to presentation slides.

4. A method as claimed in claim 4, wherein atoms corresponding to animation events within said slides are displayed in said containers, and said atoms are aligned with cue elements to generate synchronization markers for said animation events.

5. A method as claimed in any one of claim 1, wherein said synchronization markers are output into a synchronization file.

6. A method as claimed in claims 1, wherein said containers are interconnected so that as one container is displaced on the display device relative to the video stream, downstream containers are correspondingly displaced at the same time.

7. A method as claimed in claim 1, wherein said synchronization markers are timings relative to a reference point.

8. A method as claimed in claim 7, wherein said reference point is the start of the first data stream.

9. An apparatus for synchronizing first and second data streams, said first data stream acting as a reference stream and including video frames and said second data stream including a series of displayable elements, comprising:
a display device;
a first software component for displaying video frames of said first data stream along a timeline on a display device;
a second software component for displaying said containers for said displayable elements of second data stream on said display device alongside said video frames of said first data stream;
a pointer for interactively displacing containers on said display device relative to said video frames to align said containers with video cues; and
a third software component for generating synchronization markers for said aligned displayable elements relative to said first data stream.

10. An apparatus as claimed in claim 9, wherein said third software component creates a synchronization file containing said synchronization markers.

11. An apparatus as claimed in claim 9, further comprising a fourth software component for displaying displaceable atoms corresponding to animation events within said slides and generating synchronization markers for said animation events within said slides.
